(19) United States
(12) Patent Application Publication
(10) Pub. No.: US 2012/0277914 A1
(43) Pub. Date: Nov. 1, 2012

(54) Autonomous and Semi-Autonomous Modes for Robotic Capture of Images and Videos

(75) Inventors: William M. Crow, Sequim, WA (US); Nathaniel T. Clinton, Sammamish, WA (US); Malek M. Chalabi, Seattle, WA (US); Dane T. Storrusten, Los Angeles, CA (US)

(73) Assignee: MICROSOFT CORPORATION, Redmond, WA (US)

(21) Appl. No.: 13/097,294

(22) Filed: Apr. 29, 2011

(51) Int. Cl. B25J 13/08

(52) U.S. Cl. 700/259; 901/47

(57) ABSTRACT

The subject disclosure is directed towards a set of autonomous and semi-autonomous modes for a robot by which the robot captures content (e.g., still images and video) from a location such as a house. The robot may produce a summarized presentation of the content (a “botcast”) that is appropriate for a specific scenario, such as an event, according to a specified style. Modes include an event mode where the robot may interact with and simulate event participants to provide desired content for capture. A patrol mode operates the robot to move among locations (e.g., different rooms) to capture a panorama (e.g., 360 degrees) of images that can be remotely viewed.

### BACKGROUND

People often take pictures and videos to memorialize various events, as well as for other purposes. Other than for a wedding or other extremely special occasion, it is too expensive for most people to hire a professional photographer and/or videographer.

As a result, people tend to capture memories of such events by dedicating one or more individuals to take pictures and videos. Typically the dedicated person is an event participant who happens to have some interest and some level of skill in being a photographer and/or videographer. However, this means that the dedicated person is rarely captured in the pictures or videos. In a small family event where everyone is basically a key participant, the dedicated person, often a parent, tends to be missing from the photographic/video memories.

Another technique for memorializing an event is to set up a video camera on a tripod and then let it run. This works to an extent, but unless the camera is moved or changed in some way during the event, the resulting video can be rather monotonous to view, even if carefully re-edited.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a robot operates a camera to capture visible information via capture logic that executes on the robot. The visible information that is captured comprises content elements (e.g., still images, video images and/or audio). The content elements may be captured according to an operating mode, e.g., an event mode corresponding to an event, a user-directed mode that follows user commands, or a patrol mode that captures elements representing the state of a location (e.g., a room) at a particular time, e.g., images taken at various angles.

A presentation mechanism produces a presentation from some or all of the content elements. For the event mode, the presentation mechanism may select only a subset of the content elements, and assemble them into the presentation according to a user-selected style and/or parameters, such as including special effects and/or featuring a specified person based upon face detection and/or recognition. For the user-directed mode, the presentation mechanism may combine the content elements with before and after information, and use special effects according to a style. For the patrol mode, the presentation mechanism may stitch together images into a panorama, e.g., to show a 360 degree representation of a room.

The robot may be configured to allow viewing and/or editing of the presentation directly via interaction with the robot. The robot may upload the presentation to a remotely accessible location such as a portal or other site/service. The robot may save the content elements (including those not selected in the presentation) along with the presentation to a personal computer or other computing device.

In one aspect, the robot may autonomously interact with people via one or more robot output devices to stimulate the people into providing content for capture. The robot may navigate to one or more locations to encounter the people, and/or may stimulate the people into providing the content by requesting that people leave a message related to an event.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components of a robot configured to autonomously and semi-autonomously capture image and video and produce a botcast presentation.

FIG. 2 is a representation of various programs that make up a botcast system, including with different operating modes.

FIG. 3 is a flow diagram representing various example steps that may be taken by a robot when operating in an event mode.

FIG. 4 is a flow diagram representing various example steps that may be taken by a robot when operating in a director mode.

FIG. 5 is a flow diagram representing various example steps that may be taken by a robot when operating in a patrol mode.

FIG. 6 is a block diagram representing an exemplary non-limiting computing system or operating environment in which one or more aspects of various embodiments described herein can be implemented.

### DETAILED DESCRIPTION

Various aspects of the technology described herein are generally directed towards operating a robotic device (robot) in autonomous or semi-autonomous modes to capture image and/or video (including audio). Following capture, the robot provides desirable photographic and video experiences by producing a summarized content presentation of the content, such as using a stylistic theme that is appropriate for the specific scenario that was captured. In general, the content presentation may be published to a portal or the like, and thus for simplicity the technology and related aspects are sometimes referred to as a “botcast” herein.

As will be understood, the robot is controllable to operate in various modes, including an event mode in which the robot autonomously captures an event, including via interaction with the event participants, and produces a montage of images and/or short video clips, which may be delivered in an entertaining and stylized video format, e.g., with images flying in and out, sometimes in a collage-like fashion, and so on. In this mode, the robot may operate similarly to a professional photographer or videographer while capturing content, and further is capable of acting as an editor/producer to provide a desirable final product.

In another available mode, referred to as a director mode, the robot performs as directed by a user, to provide generally straightforward video recording and/or still photography, such as designed for online sharing. In another available mode, referred to as patrol mode, the robot performs an autonomous household tour or the like, e.g., as scheduled, or on-demand as requested by a user. For example, the robot may enter a room, and capture images that are then presented online as a linked collection in a (up to 360 degrees) panorama format.

It should be understood that any of the examples herein are non-limiting. For one, while the modes exemplified herein provide numerous benefits to users, other modes may be implemented that are based upon the technology described herein. Further, the technology allows for extensibility, e.g., as new modes, capture algorithms, production algorithms and the like become available in time. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and audiovisual (sound, video and/or still photography) capture and/or presentation production in general.

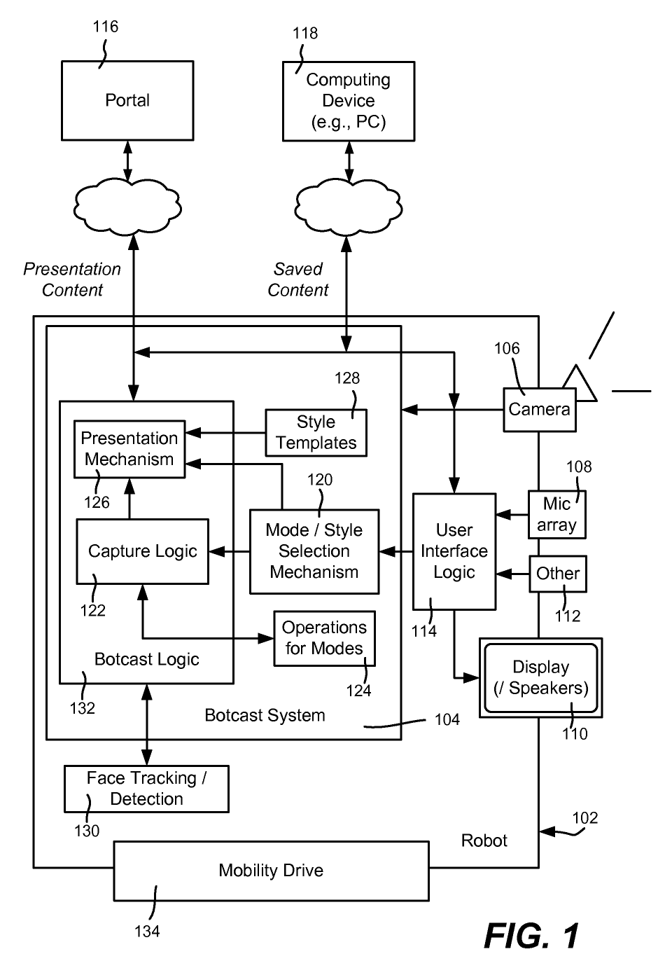

FIG. 1 is a block diagram representing example components of an example robot 102 configured with a botcast system 104. In general, the exemplified robot 102 includes a camera 106 that can capture video and/or still images (and may capture both RGB and depth data, for example). The robot 102 also includes a microphone array 108 for audio input, and a display 110, which may be a display screen and/or projection device, (and also represents speakers). Other devices 112 such as obstacle detection sensors, a remote control receiver, and so forth may be present in a given implementation.

As will be understood, the user interacts with the user interface logic 114 of the robot 102 via input gestures, speech, remote control commands, and the like. The user may also interface with the robot 102 via a portal 116 or other remote mechanism, and/or via a computing device 118 such as a personal computer or Smartphone device.

As described below, in one implementation, the user may set up an event mode or patrol mode botcast through the portal 116, e.g., by interfacing with a web application or the like. The user may control the director mode botcast via more direct interaction, e.g., via gesture, speech, and/or remote control input.

With respect to robot output, the user interface logic 114 outputs information to the user via the display 110 and/or other mechanisms, e.g., including via an expression system (e.g., sounds and LEDs, for example), via robot movement (rotation, forward or reverse driving, arm movement if an arm is present, and/or in other ways), and so forth.

In one aspect, the user inputs information to a mode/style selection mechanism 120 of the botcast system 104 to select a mode for capturing content. The content is captured via capture logic 122 (e.g., an extensible set of applications) that perform certain operations 124 related to the selected mode, such as robot movement, camera positioning, user-controlled playback, and numerous other operations as described below. In one implementation, the capture modes include the event mode, the director mode and the patrol mode, each with various associated operations 124 according to which the robot may make autonomous or semi-autonomous decisions or follow user commands for capturing content. As can be readily appreciated, the modes and related operations may be extensible to include other modes and corresponding operations, and may be customizable based upon user preferences.

The user may input a style selection, which may guide the robot in making capture-related decisions, and may be used in post-capture production. In general, in post-capture production, a presentation mechanism 126 of the botcast system 104 selects from among style templates 128 based on the input style selection to help construct a presentation from the captured content. For example, for a wedding, the style template may include slow and dream-like slideshow effects, whereas for a teenage party the slideshow effects may convey a high energy theme. Note that the presentation mechanism 126 may produce some, all or none of the presentation; for example the presentation mechanism may couple to another device such as a personal computer that produces some or all of the presentation. However, for various reasons (e.g., instant user gratification) it is desirable to be able to produce at least some form of the presentation on the robot, in one implementation.

Also shown in FIG. 1 is face tracking/detection 130, which may be used by the botcast logic 132, such as to emphasize a particular person in a presentation, as described below. A mobility drive 134 is shown to highlight the ability of the robot 102 to move through an environment while capturing content.

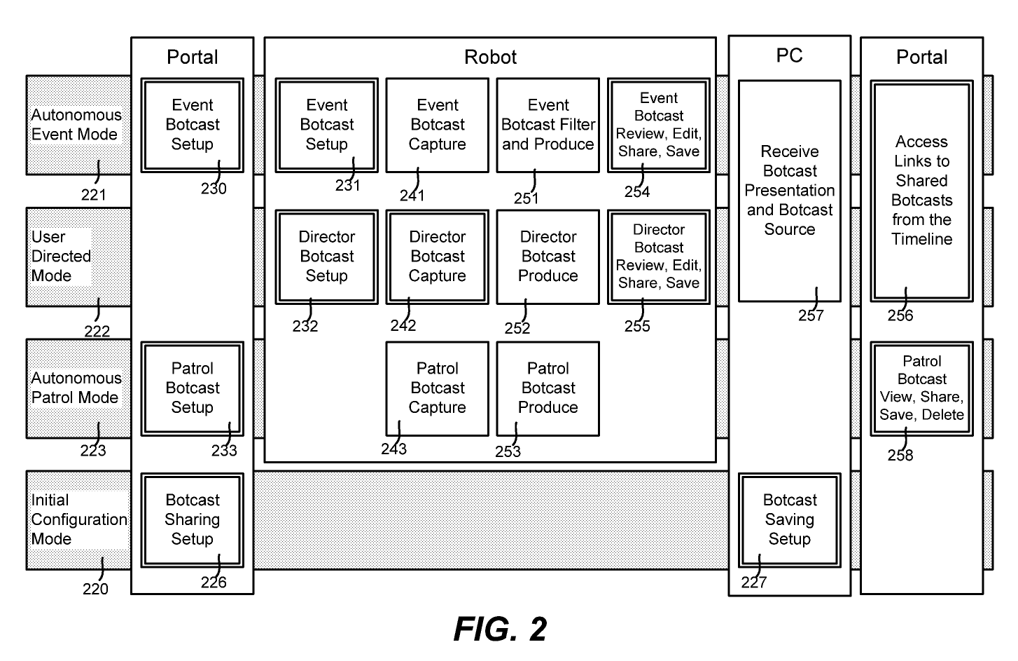

FIG. 2 shows how the various modes 220-223 are set up, performed, and then accessed based upon the selected mode, including from the perspective of the portal, the robot and a personal computer (a PC, as the example computing device 118). The modes work with various scenarios for autonomously collecting images and video clips, autonomously analyzing the captured content to select elements that are most relevant for the specific scenario, autonomously assembling the selected content into a presentation format appropriate for the specific scenario. Also described are facilities for the user to add or remove selected elements and then autonomously update the presentation format based on requested changes. Note that in one implementation, the blocks (generally representing applications or the like) that are shown as double-boxes in FIG. 2 include user interface aspects.

In an initial configuration mode 220, the user may setup a botcast for sharing by interacting with the portal (portal application 226), and set up for saving botcast-related content (PC application 227) on the personal computer. For example, via portal application 226a user may identify to the robot where a botcast presentation is to be shared, such as a social network or other online sharing service site. The user may also inform the robot of a location where botcast-related content is to be saved, a personal computer on a local network to which the robot is coupled, a file server, a cloud storage site, and so forth. Note that saving botcast-related content generally saves all of the captured content, not only the presentation, so as to allow for editing the robot-generated presentation.

In one implementation, for the autonomous event mode 221, an event botcast setup application comprises a full-featured version 230 that runs on the web portal 116, and a counterpart version 231 that runs on the robot. In this way, the user is able to select styles, input parameters (e.g., scheduled time and duration of an event, a person to emphasize), and so forth.

For the user directed (director) mode 222, the setup application 232 runs on the robot, as this mode is controlled by more direct commands via the user interface logic 114 (e.g., without using the portal 116). For the patrol mode 223, the setup application 233 is generally through the portal 116, as the user is ordinarily remote when the robot is in the patrol mode.

The operating botcast modes 221-223 include a content capture application 241-243, respectively, which is launched on demand or by a scheduled event; these applications correspond to the capture logic 122 and/or operations 124 of FIG. 1. Each of the operating botcast modes 221-223 also include botcast production-related applications, shown as 251-253, respectively, which perform filtering and composing actions with respect to producing the botcast presentation. These applications corresponding to the presentation mechanism 126 of FIG. 1, and are described below.

As represented by the robot-executed applications 254 and 255, once the botcast presentation is produced for the event mode or the director mode, the user decides what to do with it. In one implementation, event and/or director produced botcast presentations need not be uploaded to the portal, at least not right away. Instead, botcast creation is performed in the robot, and the resulting presentation made interactively viewable on the robot (which facilitates instant gratification). Simple editing (e.g., to delete shots), previewing and sharing are possible by interfacing with the robot.

The user can decide to share the botcast presentation to the portal (block 256), where it can be accessed via a link, along with any links to other shared botcasts, e.g., from a timeline user interface. The user may also save the botcast presentation, as well as other botcast content (e.g., the source material, including content that was not selected by the robot), to the computing device, e.g., a PC, where it is received (block 257). This facilitates manual and/or computer assisted editing, such as to purge unwanted or objectionable shots, substitute others, insert other material, and so forth.

For the patrol mode, the robot autonomously uploads the botcast presentation, where it is stored in available portal space, as represented by the portal application 258. Via the portal, the user can view, share, save (to another media, e.g., for insurance purposes) or delete the botcast patrol presentation. A patrol explorer/viewer may be run in the cloud, and/or on the user's PC. Note that it is feasible to perform the patrol botcast production processing (e.g., into a panorama) in the cloud by uploading the captured content as is, for example.

With respect to uploading content, the uploading may be performed by the robot in a background, UI-less process. However, transferring/storing large amounts of botcast source content with processing on the cloud can be costly with respect to resource consumption. As a result, some or all of the botcast post-production processing may be performed on the robot, e.g., during robot down time.

As can be readily appreciated, in an alternative implementation, the components and/or functionality that reside on the robot may include those that operate the camera, drive system, sensors and display, e.g., for control of the camera in the capture tasks (e.g., 241-243 in FIG. 2), with one or more remote computers performing some or all of the other processing. For example, some or all of the UI-less “filter” and “produce” tasks (e.g., 251-253) may be performed using a remote computer such as an Internet connected web server or a local area network connected personal computer or server. Some or all of the setup task processing (e.g., 231-232) may be optionally performed on remote computers, as may edit/review/share tasks (254-255) and/or any other tasks that are not part of the direct capture aspects.

Thus, one or more remote computers that perform decision making and processing tasks may be used in helping capture, filter and/or produce the various modes of botcasts, including via communication while the capture operations are taking place live. Similarly, user interaction prior to botcast capture and following botcast production may be performed using remote, network connected computers. As can be readily appreciated, this alternative approach may help reducing the cost of the robotic device, increase processing capabilities to speed botcast production (even to near-real-time results) and provide expanded computing resources for demanding computational tasks including image and sound analysis during capture, intelligent content filtering, and computationally sophisticated post-processing techniques.

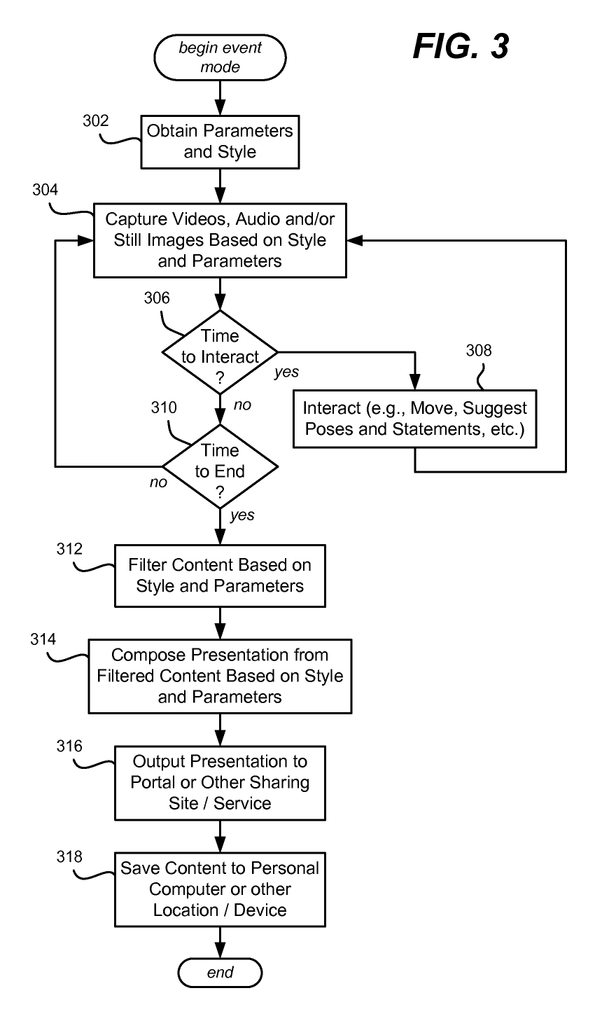

FIG. 3 shows example steps related to the event mode, which as described above has the robot create an audio visual memory of a specific event, such as within the user's home. As represented at step 302, the user is able to specify parameters and style-related data, including to schedule a specific date/time, specify a duration and one or more home locations for capturing the image and video content for the event. The user may also specify the type of event (birthday party, new baby at play, Christmas morning, costume party, and so forth) to enable the robot to employ a pre-defined stylistic template that is appropriate for the specific event type. The user may also specify additional information such as a title for the event, the identity of a featured individual at the event, and so forth to aid the robot in creating the most appropriate presentation format. Before the start time, the robot autonomously may make any preparations, such as charging its battery, making sure there is sufficient memory, and so forth.

Step 304 represents capturing content while in the event mode. The robot may use its autonomous navigation capability to navigate to the selected location at the selected start time. As described herein, the robot generally operates in an autonomous mode to capture images and/or video clips during the scheduled duration for the event.

While capturing content, the robot may base its decisions on the parameters and style information obtained at step 302. For example, if an individual is identified as a featured individual (such as the person having the birthday), the robot may capture more content related to that particular individual than others at the event. Knowing that the party is a birthday, for example, the robot may try to get a picture of the cake when the candles are lit, knowing what a birthday cake looks like in general based upon learning from and/or matching representative photographs.

As represented by steps 306 and 308, the robot may actively interact with event participants according to some schedule, such as a human photographer/videographer may do. For example, at a wedding, the robot may shoot video of the reception for a while in a “documentarian” sub-mode, and then occasionally go up to people and ask them to say something to the bride and groom, essentially stimulating testimonials from the guests in a “stimulus” sub-mode. The robot also may position itself (or be positioned, such as placed on a table) in a stationary position, such as near the guestbook that guests sign, in order to request that guests leave an audiovisual message.

The robot can detect faces, and combined with information from a depth camera, detect the person connected with the face, for example. This information may be used to frame shots, and to pan and tilt the camera to follow people as they move within a location. A person or other subject (e.g., a wedding cake) may be separated from the background by using the depth data, which provides the opportunity for many types of special effects during production processing. The robot may recognize faces associated with people it has encountered before and use this information to focus on a previously-identified featured individual, or simply to create a desirable distribution of photos that include the participants at a location.

Based upon options selected when the botcast was scheduled, the robot may use face detection to locate people, then attempt to actively engage with them, using its ability to display information, make stylistic facial expressions and create sounds to elicit specific reactions from people (such as poses, facial expressions or actions) to capture as still images or video clips. Depending on the style selection, the robot may also request that a number of participants make certain poses for a series of photographs, which the robot will later combine into something in the produced botcast presentation. For example, the robot may request that different guests each pose in such a way that when combined with other posed photographs, spell out someone's name, or if replayed rapidly, provide the appearance of a motion due to slightly different planned poses using the different participant's faces and bodies, and so on.

The robot is able to make use its many autonomous capabilities, combined with capture algorithms, to capture the most appropriate images and video clips for the particular botcast. For example, the robot may control the camera framing by panning, zooming and/or tilting as desired, such as to match the selected style. The robot may also use its autonomous navigation capability, including the ability to avoid obstacles to choose the most appropriate positions within the designated location for capturing images and video clips. This may include moving away from people who are standing to create a more pleasing framing from its lower vantage point.

Further, using a microphone array that provides directional sound detection and sound steering, the robot can detect sounds from a certain direction, listen from that direction, and/or classify those sounds as being conversation, excitement or background music/other noise. The robot may direct its camera properties for capturing images and video clips based upon the sound direction and/or classification. The robot also may sense motion in order to aim and operate its camera based upon the detected motion.

Turning to production/presentation generation aspects related to content selection, during event mode capture, the robot generates a large number of content elements comprising still images and video clips. In general, the robot does not attempt to be selective during capture, as it ordinarily has sufficient storage space. Rather, the capture logic operates to maximize the probability of capturing appropriate content, and thus captures as much as possible according to the event mode operations; note that while the event has a scheduled duration, capture can be manually terminated at any time, making it impractical to attempt to predict how much content to capture ahead of time.

After capture is complete as represented by step 310, the robot processes the captured stills and video clips to filter the content (step 312) and to compose the presentation (step 314). As part of filtering to select a subset to be included in the presentation format, the content may be processed enhance images as desired. As part of enhancing and/or filtering, the robot's presentation mechanism 126 (FIG. 1) may analyze RGB information to select content with acceptable quality exposure, may analyze frequency information and utilize edge detection techniques to choose content with acceptable focus and minimal motion blurring, and may use image comparison techniques to eliminate multiple similar images. The presentation mechanism 126 may retain similar source images that are subsequently differentiated through different cropping choices.

As part of filtering, the presentation mechanism 126 may have a target number of stills and/or video clips as defined by the user-selected stylistic template, and find similar ones in the captured content. The presentation mechanism 126 may include any number of algorithms to rank and select content.

The presentation mechanism 126 (FIG. 1) may use face detection to make decisions about cropping images, removing unwanted excess peripheral content and properly framing the subject or subjects. The presentation mechanism 126 may employ automatic exposure, color balance and sharpening algorithms to increase the perceived technical quality of an image. Using information about face recognition within photographs, the presentation mechanism 126 may attempt to create a desired distribution of event participants, and/or using timestamp information, may choose to create a desired temporal distribution.

With respect to production/composition (step 314), the presentation mechanism 126 autonomously assembles the selected image and video clips into the presentation format based on the pre-chosen stylistic template. The template generally specifies the overall structure of the presentation format, which may include graphical and audio elements, animations and transitions, titles and other overlay elements, and overall stylistic effects. The template may include placeholder locations to insert content elements with prioritized selection criteria and/or image processing recommendations for each placeholder.

Further, the post-production processing may use facial recognition to select the content for the presentation. For example, the emphasized person to be featured, such as the person whose birthday it is, may be chosen for more shots and/or video clips in the resulting presentation, with a robot-selected frequency of appearance, and/or for a longer duration when a still image is shown. As a more particular example, the robot may compose a slideshow featuring that person prominently, such as to select one of every three shots based on that person's appearance in the shot, and show each such third shot for twice as long as other shots.

Content placement criteria, which may be extensible, may include selection of close-up people shots versus wider shots, selection based on a featured person for the event, selection based on content related to a previous placeholder (which may be a temporal, content or framing relationship), and/or selection of still images versus video. An extensible set of template-defined image element processing actions may include oversaturation or desaturation, high contrast, exaggerated edge enhancement, hue shifts and other false color effects, and/or localized or otherwise stylized blur effects. Still further production actions may include depth information-based localized saturation/de-saturation effects, depth information based localized blur effects, and/or depth information based localized exposure adjustments.

An extensible set of template-defined video element processing actions may include all of the above-listed image element processing actions, plus temporal adjustments including slow motion, fast motion and various speed ramps, frame strobing (inserting alternate static or active content between or in place of individual frames in the video sequence), slow frame effects (discarding or merging frames and replicating other frames to maintain the same temporal base but with the appearance of a radically different frame rate), and so forth. Other effects such as motion blurring effects, motion trails effects, animated zooms and pans within a motion sequence, and so forth may be used.

In one implementation, the botcast template provides a detailed definition of these preferences, combined with the associated stylistic elements including graphics, audio (music and sound effects), titles and transition effects. Use of this template may be combined with a randomized selection process (e.g., within a predefined range) for many aspects of selection, processing and effects. In this way, the robot is able to autonomously create a non-monotonous, pleasing, stylized compilation from the captured stills and video clips, which is then rendered, e.g., in a standard digital audio/video encoding as the presentation format.

Once the presentation format video is complete, the robot allows the user to review it via the robot's user interface using standard media playback controls including play, pause, stop, skip ahead, skip back, and the like. At any point during review, the user may select an editing mode that allows the user the option to remove any individual captured still image or video clip. The display changes from video playback mode to content selection mode. In this mode, the user can review a linear sequence of content elements, separated from the botcast template, yet still showing any cropping choices made as part of the image processing. The user may select any item in this sequential list and remove it. The robot or user may then substitute an alternate item from the original collection of captured images and video clips. The user may continue to review selected items in the content selection mode, or return to the video playback mode to review the presentation format video, which will now reflect any changes made in the content selection mode. Note that the user may also save the content and presentation to the computing device 118, e.g., the user's PC, for editing using other tools.

The user chooses a disposition for the completed presentation, which may be based upon initial settings as described above. Options include discarding the presentation, sharing it (step 316, e.g., via a previously configured social network or other online sharing service), and/or saving it to a previously configured file storage destination on an online file storage service or personal computer (step 318). With respect to sharing, it is feasible to share based on face and/or voice recognition; for example, if one user says “share” that person can be recognized, with the result being that the robot shares the presentation to his sharing site; if his wife instead says “share,” his wife will have the presentation shared to her sharing site.

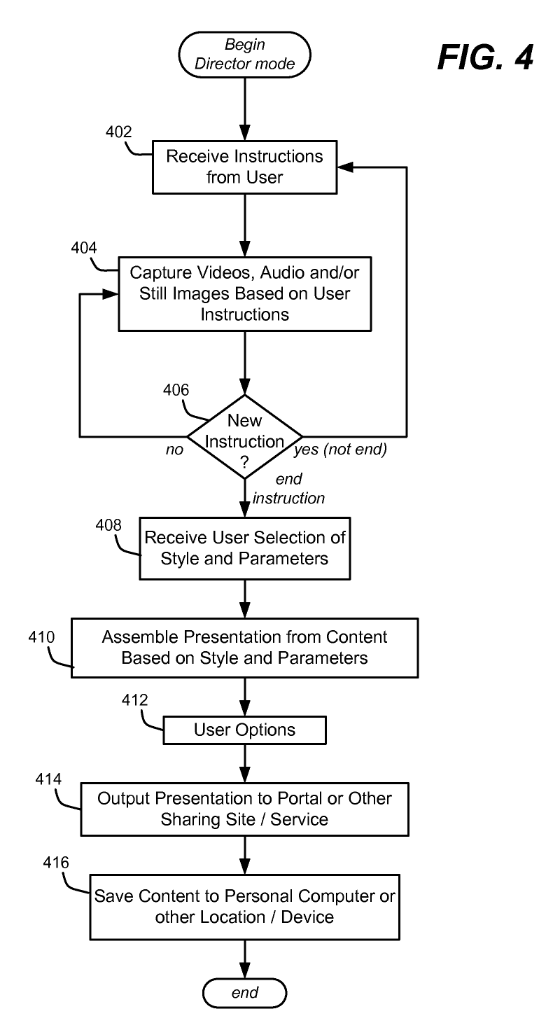

Turning to aspects of the director mode, the director mode allows the user to direct the robot to record a specific video subject or scene for a specified duration, as generally represented in the example steps of FIG. 4. Director mode botcasts are generally intended to be initiated on demand, as represented by step 402. For example, the user may initiate recording with a voice command, a gesture or a button press using the robot's remote controller.

At step 404, the robot records the content, such as by initially tracking the user through face/body tracking to keep the user within the frame. In one implementation, a default mode is for the robot to keep the camera focused on the user. If additional people are detected, the robot may attempt to frame the shot to include the other people with the user.

At any time, the user can provide a new instruction (step 406), such as to explicitly direct the robot to focus at a particular direction (e.g., pan and tilt) until instructed differently, pause, restart and so on. More particularly, while capturing content in the director mode, the robot responds to user commands to choose the subject of focus, start and/or pause recording, review and/or retake individual segments, and end recording and transition to the production phase. For example, the user can pause recording with a voice command or the remote controller. If a voice command is used, the robot sets the end of the recorded sequence to the time just before the voice command was given, ensuring that the directorial command is not included as part of the recording. Note that typically a gesture during recording is not a good option because it may or may not be a command, however it is feasible to use gestures if they are clearly distinct from other movements.

Once paused, the user can use remote control, voice or gesture commands to select among various options, such as to play back the most recently recorded segment, retake the most recent segment, which discards the previously recorded version, change the recording focus from the user to another person or to a fixed camera direction (pan and tilt position), or end the recording and proceed to post production mode (following the “end” instruction branch of step 406 to step 408).

Once the recording is complete, the director mode botcast application 252 of the presentation mechanism 126 (FIG. 1) enters post-production mode. At step 408, the user is presented the option to select a template, adjust any available template customization options, or accept a default template/default options.

At step 410, the presentation mechanism 126 automatically assembles the presentation based upon the template. To this end, the recorded segments are concatenated and combined based upon information in the template. The template may provide introductory and ending graphics including any specified titles, may include visual and audio effects such as for use in transitions between the individual segments, and may also include a music or ambient background soundtrack.

One production is complete, step 412 offers options to review, discard, share or save the completed botcast. Reviewing the botcast plays it back using the robot's media player feature. Selecting the share option uploads the Botcast (step 414) to the online sharing service that was previously configured by the user as part of the robot setup and configuration. Selecting the save option transfers the completed botcast (step 416) to the network save location as previously configured by the user as part of the robot setup and configuration.

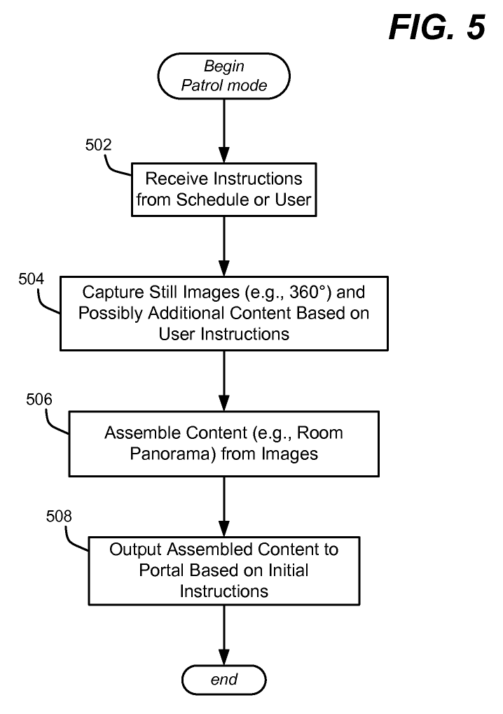

FIG. 5 is directed towards example operations in the patrol mode. In general, the robot provides the patrol mode as a way for the user to remotely monitor the house (or other location such as a business) when away. The robot is configured to periodically or on demand visit a set of one or more patrolled locations (typically, the different rooms of the household) and at each location, capture images at that state in time. For example, the robot may capture and provide a 360-degree panoramic high dynamic range, high resolution image that represents the visual state of the location at the time of capture. These panoramic images may be transferred to a web server so they are available for the user to view at any time they choose. Note that as described above the robot may stitch together the panorama, or upload the images with accompanying metadata to allow the web server or the like to build the panorama.

As represented at step 502 of FIG. 5, at the pre-scheduled time or on user demand, the robot travels to each location that has been configured as a destination for the patrol mode botcast. At each location, the robot captures a series of images (step 504) that are assembled (step 506) to create a panoramic image. It is alternatively feasible to capture video and/or audio, however the panoramic image facilitates generally more efficient interaction and/or viewing, as it allows a user to quickly view anything of interest without having to go through a video.

In one implementation, using the ability to pan and tilt the camera, the robot shoots photos at equally spaced, overlapping intervals around a 360 degree orbit. For example, at each camera position in this orbit, the robot may captures as many as twenty images, e.g., four separate images are shot at two stop exposure intervals, and the robot may select up to five different exposure settings to cover the entire high dynamic range (HDR) range as needed for each particular photo location.

If the robot detects any motion or sound while capturing the photos for the panoramic image, a brief recording of the detected sound (if any) is recorded and the location of the sound or motion within the panoramic image is recorded. Video may be recorded as well.

After the series of photos are shot for a particular home patrol location, the patrol botcast production application 253 (FIG. 2) of the presentation mechanism 126 (FIG. 1) assembles these images to create the presentation, which as described above may be a single 360 degree HDR high resolution panoramic image. For each rotational position, the set of up to five different exposures may assembled to create a single HDR image, e.g., using a floating point pixel representation to encode the extended dynamic range, which may be performed for each of the four different frames shot for each exposure. Then, the four HDR images are combined into a single higher resolution image using an appropriate super resolution technique. The set of HDR high resolution images shot at each rotational position are stitched together to form the panoramic image. The resulting high resolution HDR panoramic image is then processed to produce a tone-mapped version that can be displayed using conventional image viewing techniques.

At step 508, the botcast (e.g., comprising the HDR and the tone mapped panoramic images) is uploaded to a web server for user access, e.g., the portal as described above. A highlight thumbnail associated with any detected sound or motion may be created and uploaded to the web server, along with any associated sound files that were captured, for example.

The user can visit the web site associated with the robot at any time to view the patrol mode panoramic images and any other associated content that has been created or recorded. The web site provides access to the user via appropriate login credentials. A user interface allows the user to select a panoramic image for viewing based on the patrol time and the patrol location (room.) An online viewer optimized for progressive display of high resolution panoramic images allows the user to easily and quickly explore any area within the panoramic image.

If any motion or sound was detected when the panoramic image was shot, the thumbnails associated with those events are also displayed. If the user selects one of these thumbnails, the panoramic image is panned and zoomed to focus on the associated area within the image. If a sound and/or video recording were captured, it is played back for the user. Controls to pause, stop or replay the sound or video are also provided for the user.

In addition to reviewing each panoramic image, the user is also provided options to discard, share or save the patrol mode botcast. Selecting the share option will post an appropriate link to the online sharing service the user chooses. The save option allows the user to download a panoramic image and/or any other associated content to their local computer, for example.

As can be seen, there is provided a robotic technology configured to autonomously capture images, sound and/or video, which may be combined with additional material from a pre-defined library to autonomously produce an entertaining or informative video summary. The technology operates with limited advance information provided by the user.

In one operating mode, the user may specify a time, duration, location and theme for the desired video summary, as well as possibly identifying at least one person (e.g., from a list of known individuals) that is to be the focus of the video summary. With only this information, the device may produce an entertaining video that summarizes the event at the chosen location and time, featuring the identified individual, for example.

The device relies on a variety of known sensory and processing capabilities, including the ability to detect faces, identify faces, continuously track people once a face has been detected, detect different types of sound including the direction it comes from, and detect and classify different types of motion within its field of view. The device makes use of its autonomous navigation capabilities to choose appropriate locations for capturing images, video sequences and sounds, and may move frequently to provide a pleasing variety of images and to recognize and capture images of different participants at the event. The device may choose which images and video sequences to include in the summary video and how these are assembled based on a pre-selected template corresponding to the desired theme for the event. Algorithms may implement video effects, transitions, graphics overlays, sound track composition and/or other elements that mimic the tasks typically performed by a skilled photographer and/or video producer, however the operations are performed autonomously, with no additional input required from the user.

In another mode, the device accepts direction using voice, gesture or other commands from the user to record specific video segments. The device employs similar techniques to assemble the video segments that were captured through user control as a finished production, which may include graphics, transitions, sound compositing, overlays and other elements that mimic the work typically performed by a skilled video producer.

In another mode, the device captures a series of high-quality (e.g., panoramic) images that provide a visible record of a user's home or similar location. Each photograph is a view from a different room, location or perspective, and the robot autonomously navigates to each selected location on a predefined schedule, on demand, or randomly. The robot uses image compositing techniques, combining images at different exposures, and multiple images to increase spatial resolution and image detail, creating a panoramic image that provides an informative representation of the location as captured at the scheduled or requested time. The device interfaces with an online web service to make the panoramic images easily available for remote viewing.

### Exemplary Computing Device

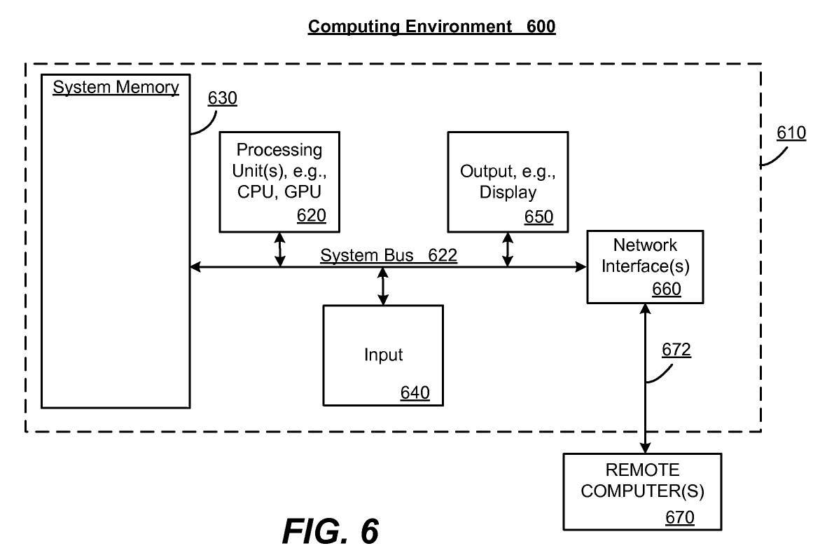

As mentioned, advantageously, the techniques described herein can be applied to any device. It can be understood, therefore, that handheld, portable and other computing devices and computing objects of all kinds including robots are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the exemplary computing system environment 600.

With reference to FIG. 6, an exemplary remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A system comprising, a robot including a camera configured to capture visible information, capture logic configured to control the camera to capture a plurality of content elements according to an operating mode, and a presentation mechanism configured to produce at least part of a presentation from at least one of the content elements.

2. The system of claim 1 wherein the robot is coupled to a mobility drive mechanism, the robot configured to use the mobility drive mechanism to navigate to capture at least some of the content elements based upon the operating mode.

3. The system of claim 2 wherein the operating mode comprises an event mode having a corresponding start time and event location, the robot navigating to have a view of the event location at or before the start time, the capture logic controlling the camera to capture at least some of the content elements at the event location.

4. The system of claim 3 wherein the presentation mechanism is configured to select a subset of the content elements that is less than a full set of the content elements, and to compose the presentation based upon the subset and a specified style for composing the presentation.

5. The system of claim 4 wherein the presentation mechanism is configured to select the subset based upon face detection or recognition, or both, and a specified person to feature in the presentation.

6. The system of claim 1 wherein the operating mode comprises a patrol mode and wherein the robot is coupled to a mobility drive mechanism, the robot navigating via the mobility drive mechanism to navigate to one or more patrolled locations in conjunction with the capture logic controlling the camera to capture at least some of the content elements at each patrolled location, including to capture content elements representing views of at least one location taken at different angles, and the robot further configured to provide remote access to the presentation.

7. The system of claim 6 wherein the presentation comprises a panoramic image built from the content elements captured at the different angles.

8. The system of claim 1 wherein the operating mode comprises a user-directed mode, the presentation mechanism assembling the presentation based upon content elements captured according to user-directed commands.

9. The system of claim 1 wherein the content elements comprise images, including one or more still images, or sequential images that comprise a video clip, or both one or more still images and sequential images that comprise a video clip.

10. The system of claim 1 wherein the presentation mechanism produces the presentation based upon a user-selectable style.

11. The system of claim 1 wherein the robot includes at least one program for playing back the presentation for review or editing, or both review and editing.

12. The system of claim 1 wherein the robot includes at least one program for uploading the presentation to a remote access location.

13. The system of claim 1 wherein the robot includes at least one program for saving at least some of the content elements to a computing device.

14. The system of claim 1 wherein the robot includes programming for playing back the presentation for review or editing, or both review and editing.

15. In a computing environment, a method performed at least in part on at least one processor, comprising, operating a robot to capture content elements via a robot camera, including autonomously interacting with people via one or more robot output devices to stimulate the people into providing content for capture.

16. The method of claim 15 wherein autonomously interacting with the people comprises navigating to one or more locations to encounter the people.

17. The method of claim 15 wherein autonomously interacting with the people participants to stimulate the people into providing the content comprises requesting at least one person to leave a message related to an event.

18. The method of claim 15 further comprising, autonomously producing a presentation from the content elements.

19. One or more computer-readable media having computer-executable instructions, which when executed perform steps, comprising, operating a robot in one of a plurality of modes to capture content elements according to that mode, including steps that control the robot to autonomously move to different capture locations and to autonomously operate a robotic camera to capture content at each location.

20. The one or more computer-readable media of claim 19 having further computer-executable instructions comprising, producing a presentation from the content elements.
